(19) United States
(12) Patent Application Publication
(10) Pub. No.: US 2025/0150542 A1
(43) Pub. Date: May 8, 2025

(54) IMAGE FORMING DEVICE

(71) Applicant: SEIKO EPSON CORPORATION, TOKYO (JP)

(72) Inventors: Keita FUJI, Nakama-shi (JP); Shintaro MIYAMOTO, Shiojiri-shi (JP); Keiichiro FUKUMASU, KITAKYUSHU-SHI (JP)

(21) Appl. No.: 18/939,597

(22) Filed: Nov. 7, 2024

(30) Foreign Application Priority Data
Nov. 7, 2023 (JP) 2023-189935

(51) Int. Cl. H04N 1/00

(52) U.S. Cl. CPC H04N 1/00809; H04N 1/0083

(57) ABSTRACT

An image forming device includes a reading device that transports a document by a document transport section, and a device body includes a recording section that records on a medium and a control section, wherein the device body includes a control board, on which the control section is provided, the reading device is provided so as to be openable and closable with respect to the device body by rotating about an axis located on the rear side of the device body, a relay board on the reading device lower surface that covers the upper portion of the device body, the document transport section and the control section are electrically connected by connecting the relay board and the control board with a cable, the relay board cover that protects the relay board and the cable extending from the relay board is provided on the reading device lower surface.

The present application is based on, and claims priority from JP Application Serial Number 2023-189935, filed Nov. 7, 2023, the disclosure of which is hereby incorporated by reference herein in its entirety.

### BACKGROUND

### 1. Technical Field

The present disclosure relates to an image forming device.

### 2. Related Art

JP-A-2005-258025 discloses an image forming device provided with a printer section and a scanner section connected to an upper portion of the printer section by a rotary support member so as to be openable and closable with respect to the printer section. The printer section has an image forming means that records an image on a recording material. The scanner section reads the document and supplies the read image information to the image forming means. A cylindrical member configured integrally with the scanner section is provided in the vicinity of a rotation support member of the scanner section. All electric wire members connecting the scanner section and the printer section are wired inside the cylindrical member, and the electric wire members are covered by the cylindrical member even in a state where the scanner section is opened.

However, in the image forming device disclosed in JP-A-2005-258025, when a wire member connecting the scanner section and the printer section is damaged due to the opening and closing operation of the scanner section, the wire member may not be easily removed from the scanner section.

### SUMMARY

The image forming device includes a reading device that has a document transport section for transporting a document and that reads the document and a device body including a recording section that records on a medium and a control section that controls the document transport section, wherein the device body includes an internal control board on which the control section is provided, and the reading device is provided so as to be openable and closable between an open position that exposes an upper portion of the device body and a closed position that covers the upper portion, by rotating about an axis located on the rear side of the device body and includes a relay board that is on a reading device lower surface and that covers the upper portion of the device body, the document transport section and the control section are electrically connected by connecting the relay board and the control board with a cable, and a relay board cover that protects the relay board and the cable extending from the relay board is provided on the reading device lower surface.

### BRIEF DESCRIPTION OF THE DRAWINGS

FIG. 1 is a perspective view showing an embodiment of an image forming device.

FIG. 2 is a perspective view showing the device body and the reading device.

FIG. 3 is a partial cross-sectional view showing the document transport section of the reading device.

FIG. 4 is an enlarged view of a portion d4 shown in FIG. 3.

FIG. 5 is a cross-sectional view showing a device body and a reading device.

FIG. 6 is a cross-sectional view showing a device body and a reading device.

FIG. 7 is a partial top view showing the device body.

FIG. 8 is a partial top view showing the device body.

FIG. 9 is a partial cross-sectional view of the reading device showing the electrical connection between the document transport section and the control section.

FIG. 10 is a partial bottom view of the reading device showing the electrical connection between the document transport section and the control section.

FIG. 11 is a partial perspective view of the reading device showing the electrical connection between the document transport section and the control section.

FIG. 12 is a partial cross-sectional view of the reading device and the device body showing the electrical connection between the document transport section and the control section.

FIG. 13 is a partial perspective view of the reading device and the device body showing the electrical connection between the document transport section and the control section.

FIG. 14 is a partial perspective view of the device body showing the electrical connection between the document transport section and the control section.

### DESCRIPTION OF EMBODIMENTS

Hereinafter, the present disclosure will be described based on embodiments. In each drawing, the same members are denoted by the same reference symbols, and a duplicate description will be omitted. In the present specification, “same”, “identical”, and “simultaneous” do not indicate only being completely the same. For example, in the present specification, “same”, “identical”, and “simultaneous” include the case of being the same in consideration of a measurement error.

For example, in the present specification, “same”, “identical”, and “simultaneous” include cases where the parts are the same in consideration of manufacturing variations. For example, in the present specification, “same”, “identical”, and “simultaneous” include cases where they are the same to extent that they do not impair function. Therefore, for example, “both dimensions are the same” means that a dimensional difference between both dimensions is within a±5% of one of the dimensions, particularly preferably within±3%, in consideration of measurement errors and manufacturing variations of the parts.

### 1. First Embodiment

The image forming device 11 is, for example, an inkjet printer capable of recording on a medium M such as a printing sheet.

In each drawing, X, Y, and Z represent three spatial axes orthogonal to each other. In the present specification, directions along these axes are referred to as the X-axis direction, the Y-axis direction, and the Z-axis direction. In a case where a direction is specified, a positive direction is referred to as “+”, a negative direction is referred to as “−”, positive and negative signs are used together for direction notation, a direction in which an arrow in each drawing is directed is referred to as a +direction, and a direction opposite to the arrow is referred to as a −direction.

The Z-axis direction indicates the direction of gravity, the +Z direction indicates vertically downward direction, and the −Z direction indicates vertically upward direction. A plane including the X-axis and Y-axis is described as the X-Y plane, a plane including the X-axis and Z-axis as the X-Z plane, and a plane including the Y-axis and Z-axis as the Y-Z plane. The X-Y plane is a horizontal plane. Three spatial axes of X, Y, and Z that do not limit the positive direction and the negative direction will be described as an X-axis, a Y-axis, and a Z-axis.

The X-axis direction is a direction intersecting the transport direction of the medium M in the device body 12, that is, the width direction of the medium M, and is also a width direction of the image forming device 11, the reading device 61, and the device body 12. The X-axis direction is a horizontal direction along a mounting surface G, which is a horizontal plane on which the image forming device 11 is mounted. The +X direction is the left side and the −X direction is the right side when viewed from the operator positioned on the front side of the image forming device 11. In the present embodiment, the front surfaces of the image forming device 11, the reading device 61, and the device body 12 are the surfaces on the side where a notification section 22 is provided.

The Y-axis direction is a depth direction of the image forming device 11, the reading device 61, and the device body 12. The Y-axis direction is a horizontal direction along a mounting surface G which is a horizontal plane on which the image forming device 11 is disposed. The +Y direction in the Y-axis direction is a direction from the rear surface to the front surface of the image forming device 11, the reading device 61, and the device body 12. In the Y-axis direction, the −Y direction is a direction from the front surface to the rear surface of the image forming device 11, the reading device 61, and the device body 12.

The Z-axis direction is a normal direction with respect to the placement surface G, and is a height direction of the image forming device 11, the reading device 61, and the device body 12. In the following description, the +Z direction may be referred to as “downward”, and the −Z direction may be referred to as “upward”.

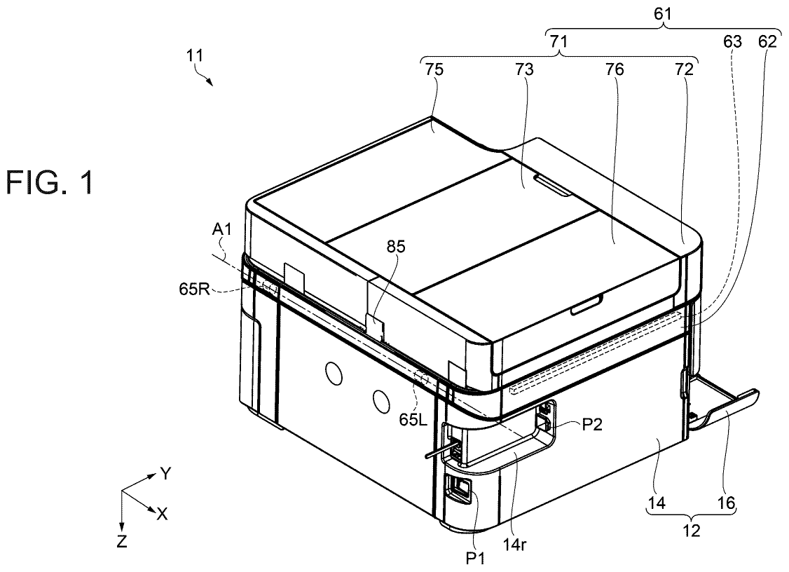

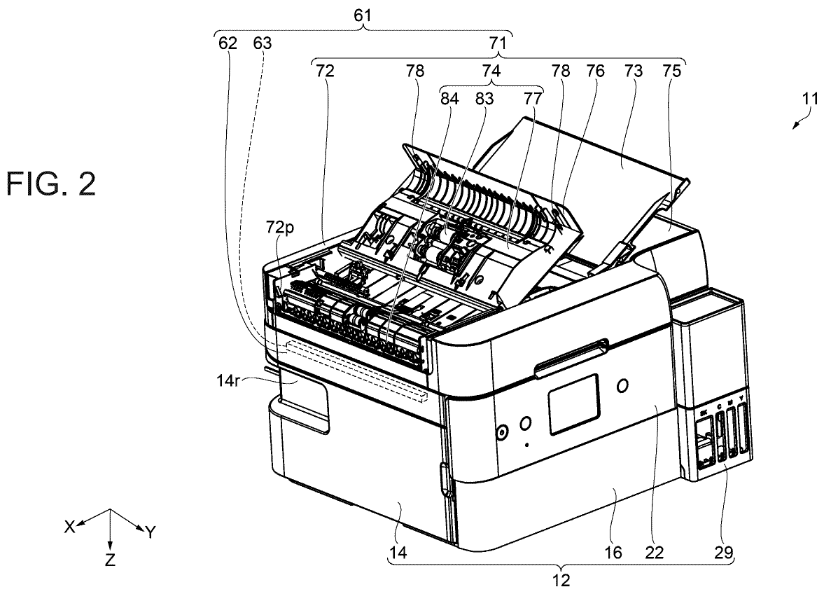

As shown in FIGS. 1 and 2, the image forming device 11 includes a reading device 61, a device body 12, and a notification section 22.

The reading device 61 reads the document. The reading device 61 includes a reading device housing 62 that is a housing of the reading device 61, a reading sensor 63 that reads a document, and a document cover 71. The reading device 61 is provided vertically above the −Z direction of the device body 12 in the Z-axis direction. Rotation shafts 65R and 65L are provided at the end of the −Y direction of the reading device housing 62.

The rotation shaft 65R is provided on the −X direction side from the center of the reading device housing 62. The rotation shaft 65L is provided on the +X direction from the center of the reading device housing 62. The rotation shafts 65R and 65L are attached to bearings 17R and 17L of the device body 12 (to be described later).

Thus, the reading device 61 is attached to the device body 12 so as to be rotatable about the axis A1 located on the −Y direction from the center, which is the rear side of the device body 12. The reading device 61 can be opened and closed between an open position and a closed position by rotating about axis A1 along the X-axis. The open position is a position at which the reading device 61 opens the upper side of the device body 12 which is the −Z direction of the device body 12 so that the inside of the device body 12 can be accessed. The closed position is a position at which the reading device 61 covers the −Z direction of the device body 12.

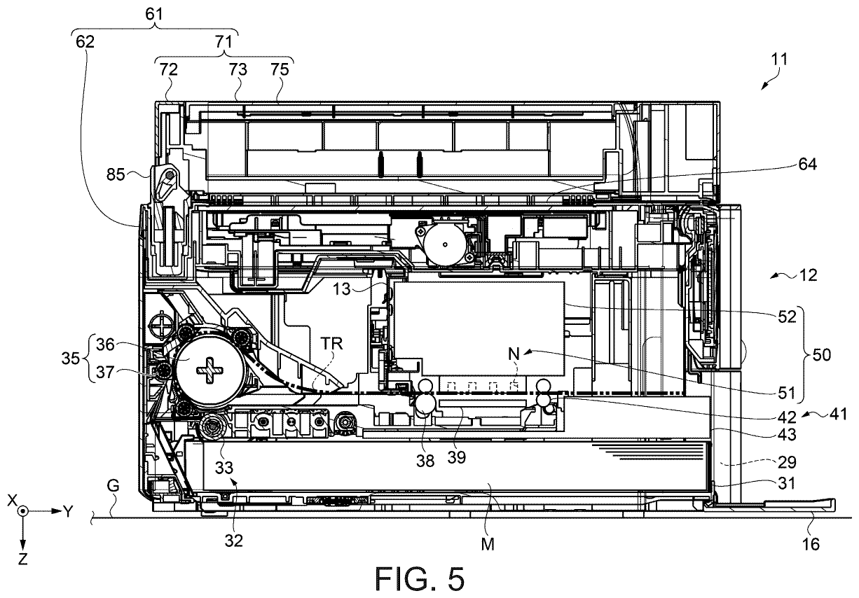

The document cover 71 is provided vertically above the reading device 61 on the −Z direction. The document cover 71 is connected to the reading device 61 by a hinge 85 so as to be openable and closable between a closed position (see FIG. 1) at which the −Z direction of the reading device 61 is covered and an open position (not shown) at which the −Z direction of the reading device 61 is open. The document cover 71 is opened and closed when a user sets a document on a document table 64 (see FIG. 5) of the reading device 61 to read the document. The document cover 71 includes a cover housing 72 which is a housing of the document cover 71, a document supply tray 73, a document transport section 74 (see FIG. 2), a document discharge tray 75, and a transport section cover 76.

The document is placed on the document supply tray 73. The document supply tray 73 is attached to the cover housing 72 so as to be openable and closable to an open position (see FIG. 2) at which a document can be placed and to a closed position (see FIG. 1) at which the cover housing 72 covers a document transport path along which the document is transported.

As shown in FIG. 2, the document transport section 74 transports a document placed on the document supply tray 73 toward the reading sensor 63 by a plurality of document transport rollers 83 and document nip rollers 84. The document transport section 74 transports a document from which an image or the like has been read by the reading sensor 63 of the reading device 61 toward the document discharge tray 75.

A document whose image or the like has been read by the reading device 61 is discharged to the document discharge tray 75. The document discharge tray 75 is attached to the cover housing 72 so as to be openable and closable to an open position (see FIG. 2) where the document can be discharged and a closed position (see FIG. 1) that covers the transport path where the document is transported.

The transport section cover 76 is attached to the cover housing 72 so as to be openable and closable between a closed position (see FIG. 1) at which the transport path is covered and an open position (see FIG. 2) at which the −Z direction of the transport path is opened. The open position of the transport section cover 76 is a position at which the transport path can be accessed. By setting the transport section cover 76 to the open position, for example, the user can remove a document remaining in the transport path.

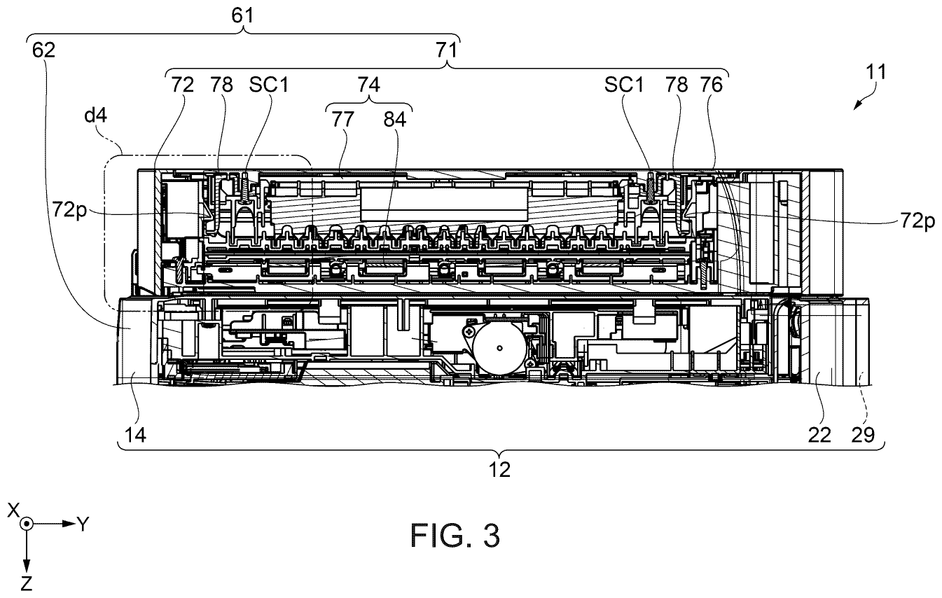

As shown in FIGS. 2 and 3, engagement claw members 78 are provided at both ends of the transport section cover 76 in the Y-axis direction. When the transport section cover 76 is in the closed position, the engagement claw member 78 engages with a protrusion 72p provided on the cover housing 72, to fix the position of the transport section cover 76 in the closed position.

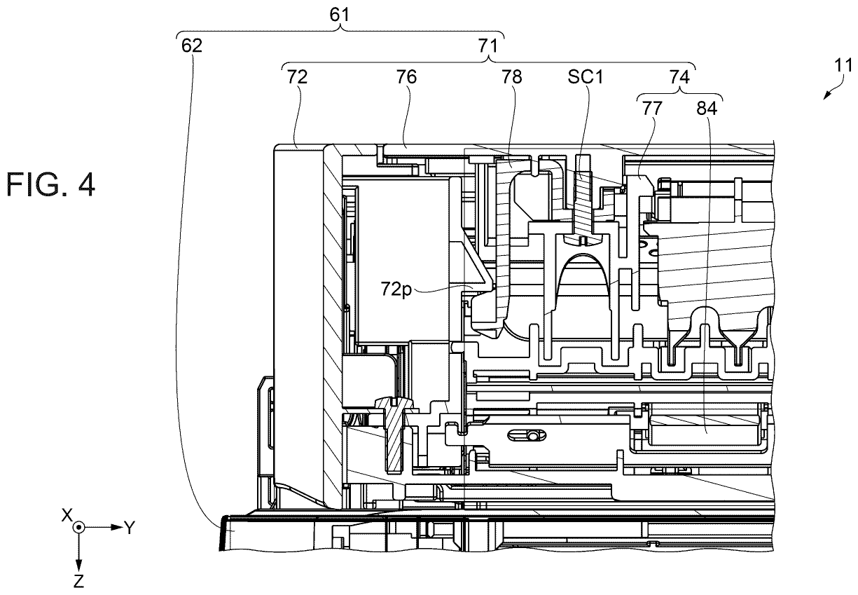

As shown in FIGS. 3 and 4, the engagement claw member 78 is fixed to the transport section cover 76 by a screw SC1 in a state of being sandwiched between a guide member 77, which guides the document, and the transport section cover 76. The engagement claw member 78 is formed of a resin material that is easily bent and that has good sliding property, for example, POM (Polyoxymethylene) or the like.

The engagement claw member 78 of the present embodiment can be removed from the transport section cover 76 and the guide member 77 by removing the screw SC1. Therefore, the engagement claw member 78 can be easily replaced. According to this, as compared to the case where the engaging claw on the transport section cover 76 is formed integrally with the transport section cover 76, for example, the ease of maintenance of the transport section cover 76 is improved in the case that the engaging claw is broken. According to this configuration, since the transport section cover 76 and the engagement claw member 78 are separate members, it is possible to select the most suitable material for each of them. For example, the engagement claw member 78 having a relatively small volume can be made of a high-cost material with good material characteristics.

For example, the transport section cover 76 having a relatively large volume can be made of a recycled resin material. This will contribute to the achievement of the Sustainable Development Goals (SDGs) such as Goal 12 “Ensure sustainable consumption and production patterns” and Goal 14 “Conserve and sustainably use the oceans, seas and marine resources for sustainable development”. By configuring the transport section cover 76 from a recycled resin material, it is possible to reduce the cost of the transport section cover 76.

As shown in FIG. 2, the notification section 22 is provided in the reading device housing 62 of the reading device 61. The notification section 22 is provided at a position which is an end of the front surface of the reading device housing 62 on the +Y direction. The notification section 22 is provided to be rotatable around an axis along the X axis with respect to the reading device housing 62. The notification section 22 has a monitor, a touch panel, and the like, and notifies the user by displaying a message.

As shown in FIGS. 5 to 7, the device body 12 includes a medium supply section 31, a feeding section 32, a transport section 35, a medium support section 39, and a recording section 50. The device body 12 includes a discharge section 41, a placement tray 43, a front cover 16, a liquid container 29, bearings 17R and 17L, and an electrical section 90. In FIGS. 5 to 7, the transport path TR along which the medium M is transported is indicated by two dot chain line.

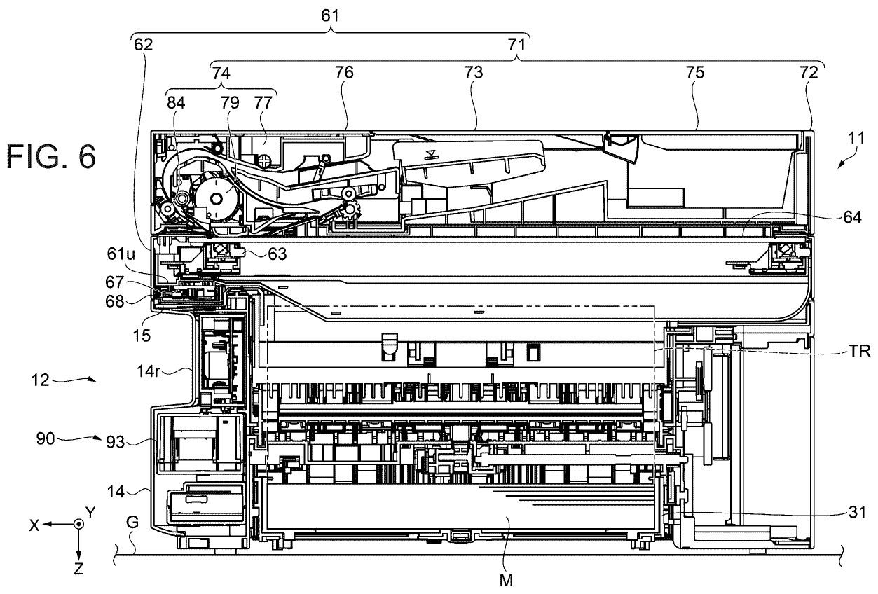

As shown in FIGS. 5 and 6, the housing of the device body 12 is formed by attaching a plurality of exterior members including an exterior member 14 that defines the outline on the +X direction to a frame member including a carriage frame 13. The carriage frame 13 supports a carriage 52 of the recording section 50 to be movable in the X-axis direction. For this reason, the carriage frame 13 is provided at the center of the device body 12 in the Y-axis direction, and extends in the X-axis direction so as to divide the inside of the device body 12 into a front side region on the +Y direction and a rear side region on the −Y direction.

The medium supply section 31 can accommodate plural sheets of medium M in a stacked state. The medium supply section 31 is provided in the device body 12 so as to be movable to a supply position (see FIG. 5) at which the medium M to be accommodated can be delivered to the transport path TR and a set position (not shown) on the +Y direction of the supply position. The set position of the medium supply section 31 is a position at which the medium M can be set in the medium supply section 31.

The feeding section 32 includes a pickup roller 33. The pickup roller 33 rotates in a state of being in contact with the medium M accommodated in the medium supply section 31, thereby sending the medium M located at the uppermost position toward downstream of the transport path TR. The feeding section 32 feeds the medium M accommodated in the medium supply section 31 to the transport path TR one sheet at a time.

The transport section 35 transports the medium M along the transport path TR. The transport section 35 includes an inversion roller 36, a nip roller 37, and a transport roller pair 38, which are provided along the transport path TR. The inversion roller 36 and the nip roller 37 transport the medium M toward the transport roller pair 38 by rotating in a state in which the medium M is nipped therebetween. The inversion roller 36 and the nip roller 37 reverse the transport direction of the medium M from the −Y direction to the +Y direction. The transport roller pair 38 transports the medium M toward the medium support section 39 by rotating in a state in which the medium M is nipped therebetween.

The medium support section 39 is provided at a position facing the recording section 50 with the transport path TR interposed therebetween. The medium support section 39 supports at least a portion of the medium M on which recording is performed.

The recording section 50 includes a head 51 and a carriage 52. The head 51 includes a plurality of nozzles N capable of ejecting liquid. The head 51 is mounted on the carriage 52. The carriage 52 is movably supported on the carriage frame 13 in the X-axis direction. The recording section 50 performs recording on the medium M by ejecting ink, which is an example of a liquid, from the nozzle N of the head 51 mounted on the carriage 52 that moves in the X-axis direction.

The discharge section 41 discharges the medium M recorded by the recording section 50 to the placement tray 43. The discharge section 41 includes a discharge roller pair 42. The discharge roller pair 42 transports the medium M toward the placement tray 43 on the downstream in the transport direction by rotating in a state in which the of medium M is nipped therebetween.

The medium M discharged by the discharge section 41 is placed on the placement tray 43. The placement tray 43 is provided at a position between the recording section 50 and the medium supply section 31 at the supply position in the Z-axis direction. The placement tray 43 may be provided in the device body 12 so as to be movable between a storage position at which the placement tray 43 is stored inside the device body 12 and a placement position at which the placement tray 43 protrudes to the +Y direction of the device body 12 and at which the medium M is placed.

The front cover 16 is provided on the device body 12 so as to be openable and closable around an axis along the X-axis as a rotation center. The front cover 16 is movable to a closed position (see FIG. 2) at which the front cover 16 covers the +Y direction of the placement tray 43 and the medium supply section 31 in the supply position, and to an open position (see FIG. 5) at which the front cover 16 is positioned at the +Z direction of the medium supply section 31. When the front cover 16 is in the open position, the medium supply section 31 is movable between the supply position and the set position. When the placement tray 43 is movable between the storage position and the placement position, the front cover 16 may move from the closed position to the open position in conjunction with the movement of the placement tray 43 from the storage position to the placement position.

The liquid container 29 contains the ink to be ejected by the recording section 50. The liquid container 29 is provided in a region on the −X direction of the transport path TR in the front surface side region on the +Y direction of the carriage frame 13. The liquid container 29 is connected to the recording section 50 by a supply tube (not shown) so as to be able to supply ink to the recording section 50.

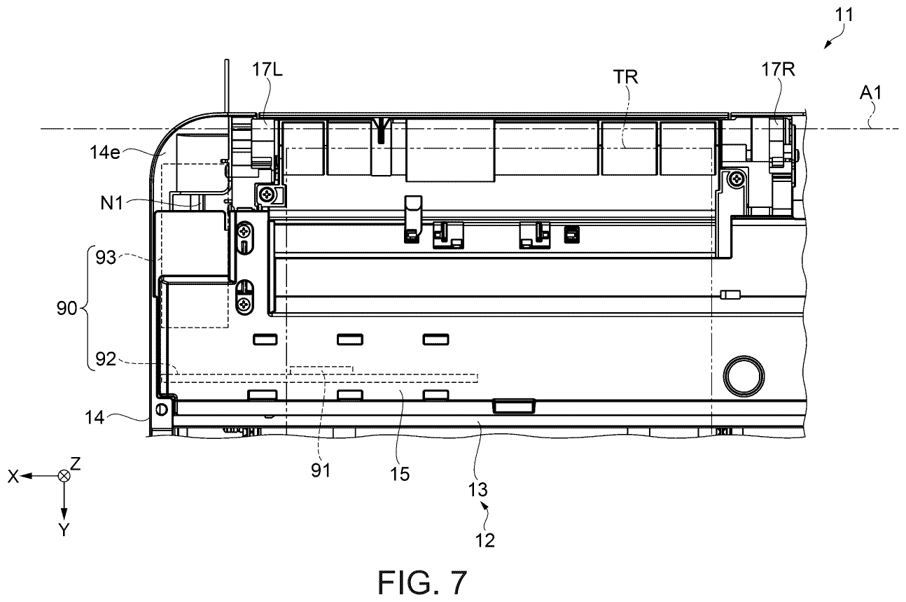

As shown in FIG. 7, the bearings 17R and 17L are provided at the end on the −Y direction, which is the rear side of the device body 12. The bearing 17 R is provided at a position adjacent to the transport path TR at the −X direction side. The bearing 17 L is provided at a position adjacent to the transport path TR at the +X direction side. The rotation shafts 65R and 65L of the reading device 61 are attached to the bearings 17R and 17L, so that the reading device 61 is attached to the device body 12 so as to be rotatable about the axis A1.

The electrical section 90 is provided in the device body 12 on the rear side region, which is the −Y direction of the carriage frame 13. The electrical section 90 includes electric circuits such as the control section 91 and the power supply section 93.

The control section 91 integrally controls the driving of each mechanism in the image forming device 11, and controls various operations executed in the image forming device 11. The control section 91 may be configured as circuitry including one or more processors for executing various processes according to a computer program, one or more hardware circuits for executing at least a part of the various processes, or a combination thereof. The hardware circuit is, for example, an application-specific integrated circuit. The processor includes a CPU and memory, such as RAM and ROM, and the memory stores program code or instructions configured to cause the CPU to perform processes.

For example, the control section 91 controls the feeding section 32, the transport section 35, the recording section 50, and the discharge section 41 to transport the medium M on which recording has been performed by the recording section 50 toward the placement tray 43. The control section 91 controls the document transport section 74 and the reading sensor 63 to discharge the document from which an image or the like is read by the reading sensor 63 to the document discharge tray 75. The control section 91 notifies the user of the state of the image forming device 11 by controlling the notification section 22 to display a message on the monitor of the notification section 22.

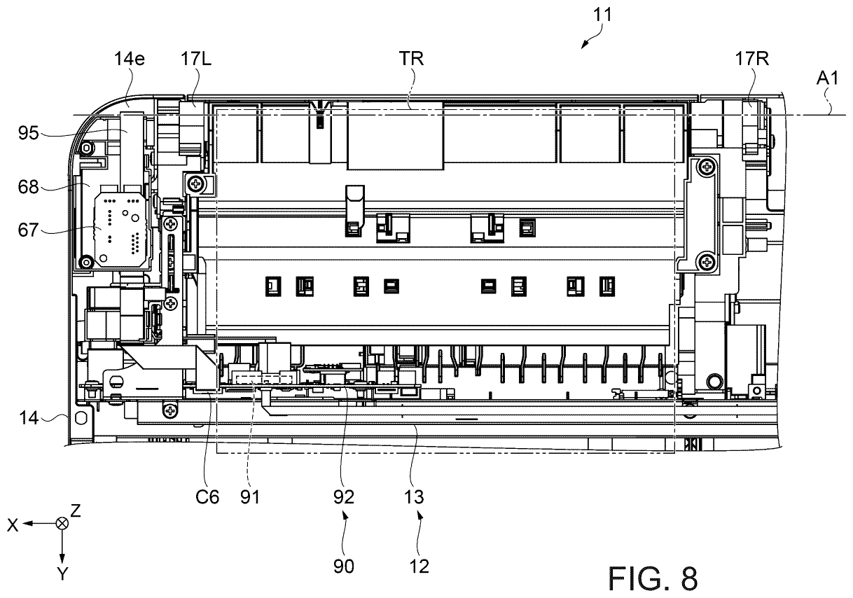

As shown in FIG. 7 and FIG. 8, the control board 92 on which the control section 91 is provided is located in the rear side region of the device body 12. The control board 92 is attached to the −Y direction of the carriage frame 13 such that the board surface is along the X-Z plane. The control board 92 is positioned on the −Z direction of the transport path TR. The control board 92 extends in the X-axis direction over the center from the +X direction end of the device body 12. For explanation, FIG. 8 shows a cable 95, and a relay board 67 and a relay board cover 68 of the reading device 61 (all to be described later). For explanation, in FIG. 8, the electrical component cover 15 (to be described later) is removed.

The power supply section 93 adjusts the voltage of the electric power supplied to each component of the image forming device 11. As shown in FIG. 7, the power supply section 93 is provided at a position on the +X direction of the transport path TR. Power supply section 93 is provided at a position to the −Y direction of the control board 92.

An electrical component cover 15 that covers the electrical section 90 is provided on the −Z direction above the electrical section 90 including the control board 92 and the power supply section 93. The electrical component cover 15 is provided so as to be slidable in the +X direction by detaching the exterior member 14 from the frame member. As a result, for example, the control board 92 becomes accessible from above.

As shown in FIG. 1, the exterior member 14 exposes a plurality of ports such as a power port P1 and a USB port P2 into which connection terminals such as a power cable and a Universal Serial Bus (USB) are plugged. The USB port P2 is exposed to the recessed section 14r provided in the exterior member 14. The recessed section 14r is a depression extending in the +Y direction from the rear surface of the device body 12. As shown in FIG. 6, the recessed section 14r is positioned above the power supply section 93 on the −Z direction.

As shown in FIG. 7, the exterior member 14 is provided with an extension section 14e covering the −Z direction side, which is above the electrical section 90. The extension section 14e covers the upper side of a region of the electrical section 90 that is between the bearing 17L and the +X direction end of the device body 12 of the X-axis direction, and that is between the −Y direction end of the device body 12 and the electrical component cover 15. By the electrical component cover 15 and the extension section 14e, a notch-like gap N1 extending in the X-axis direction is formed between the −Y direction end of the electrical component cover 15 and the extension section 14e. The gap N1 is open on the −X direction side.

Next, a connection structure between an electric component provided in the document transport section 74 of the reading device 61 and the control section 91 provided on the control board 92 will be described. The control board 92 and the electric component provided in the document transport section 74 are electrically connected to each other via electric wires WR, the relay board 67, and the cable 95.

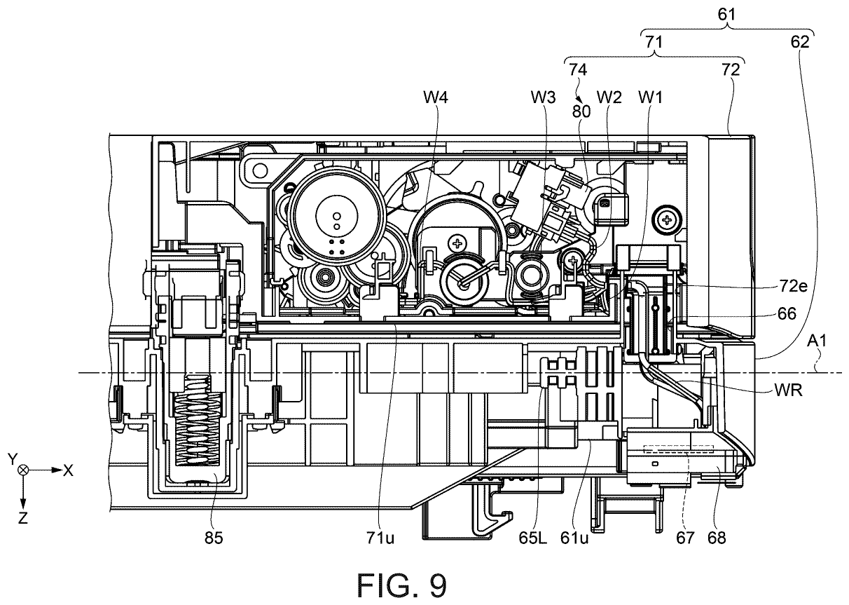

As shown in FIG. 9, the electrical components provided in the document transport section 74 include the document transport motor 79 (see FIG. 6), the encoder 80, a document end detection sensor 81 (not shown), and a document detection sensor 82 (not shown). The document transport motor 79 drives the document transport roller 83. The encoder 80 that detects the rotation amount of the document transport motor 79. The document end detection sensor 81 detects the edge of the document. The document detection sensor 82 detects the presence or absence of the document.

The electric wires WR connected to the electrical components provided in the document transport section 74 include wires W1, W2, W3, and W4 connected to the document transport motor 79, the encoder 80, the document end detection sensor 81, and the document detection sensor 82. The electric wires WR pass through an outlet 72e and a communication hole 66, and are drawn out in the +Z direction of a reading device lower surface 61u.

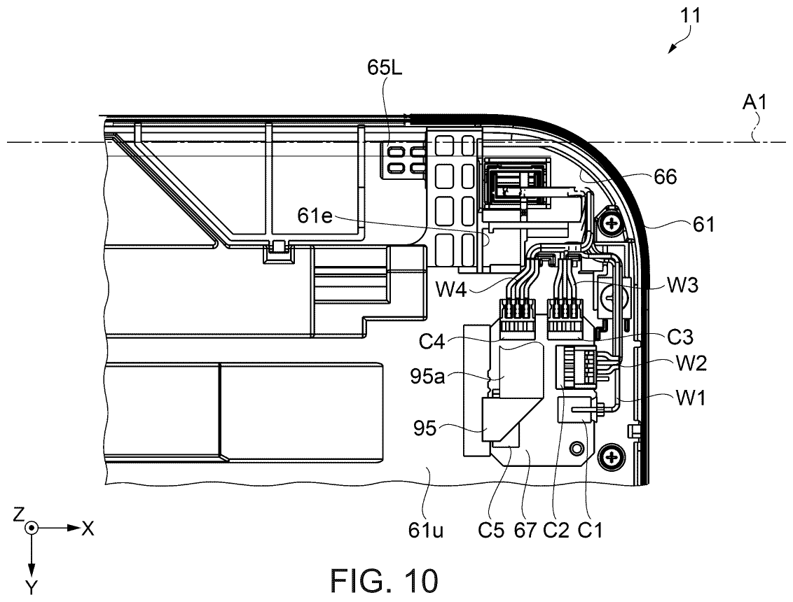

The outlet 72e is a through hole provided in a document cover lower surface 71u, which is a surface in the +Z direction of the cover housing 72. The communication hole 66 passes through the reading device housing 62 in the Z-axis direction. The communication hole 66 is opened in the reading device lower surface 61u which is a surface of the reading device housing 62 in the +Z direction. The reading device lower surface 61u covers the −Z direction of the device body 12 when the reading device 61 is in the closed position. As shown in FIG. 10, the communication hole 66 is opened at an end on the −Y direction, which is the rear side, of the reading device lower surface 61u, and at a position adjacent to the +X direction side of the rotation shaft 65L. For explanation, FIG. 10, the relay board cover 68 (to be described later) is removed.

As shown in FIG. 10, the relay board 67 is attached along the X-Y plane to the +Z direction side of the reading device lower surface 61u. The relay board 67 is provided on the reading device lower surface 61u at a position that is adjacent to the +Y direction side of the opening of the communication hole 66 and that is further to the −Y direction side, which is the rear side, than is the center. The relay board 67 is provided at a position between the rotation shaft 65L and the +X direction end of the reading device lower surface 61u with respect to the X-axis direction. Therefore, the relay board 67 is provided at a position closer in the Y-axis direction to the axis A1 than is the center of the reading device 61.

As shown in FIG. 6, the relay board 67 is positioned vertically below the document transport motor 79 when the reading device 61 is in the closed position. When the reading device 61 is in the closed position, the relay board 67 is positioned vertically above the recessed section 14r. When the reading device 61 is in the closed position, the relay board 67 is positioned vertically above the power supply section 93.

As is clear from FIGS. 7 and 8, when the reading device 61 is in the closed position, the relay board 67 is positioned vertically above the −Y direction end of the electrical component cover 15. When the reading device 61 is in the closed position, the relay board 67 is positioned vertically above the +Y direction end of the extension section 14e. When the reading device 61 is in the closed position, the relay board 67 is positioned vertically above the gap N1. In other words, when the reading device 61 is in the closed position, the relay board 67 is positioned vertically above a region of the device body 12 which is on the +X direction side of the transport path TR and on the −Y direction side of the center of the device body 12.

As shown in FIG. 10, connectors C1, C2, C3, C4, and C5 are provided on the surface of the relay board 67 on the +Z direction. The electric wire W1 is connected to the connector C1. The electric wire W2 is connected to the connector C2. The electric wire W3 is connected to the connector C3. The electric wire W4 is connected to the connector C4. As a result, the electrical components of the document transport section 74 and the relay board 67 are electrically connected. A cable 95 is connected to the connector C5. The cable 95 is a flexible flat covered wire, a so-called flexible flat cable (FFC).

Each of the wires W1, W2, W3, W4, and the cable 95 are connected to and disconnected from the relay board 67 by being plugged into and unplugged from each of the connectors C1, C2, C3, C4, and C5 along the X-Y plane, that is, along the reading device lower surface 61u.

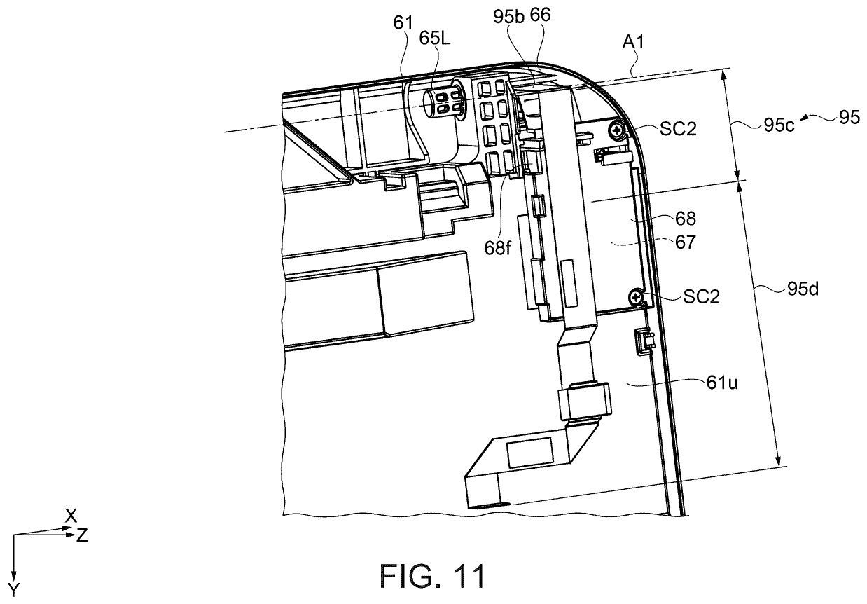

As shown in FIGS. 8, 9, and 11, the relay board cover 68 is provided on the +Z direction of the relay board 67. The relay board cover 68 protects the relay board 67 and the advancing section 95a (see FIG. 10) of the cable 95. As shown in FIG. 11, the end of the relay board cover 68 in the −Y direction extends toward the opening of the communication hole 66 located obliquely upward, and enters the communication hole 66.

The relay board cover 68 is detachably fixed to the reading device lower surface 61u by screws SC2 and a mounting claw 68f. The mounting claw 68f is an engagement protrusion provided on the relay board cover 68 so as to be engageable with an engaged section 61e (see FIG. 10) provided on the reading device lower surface 61u.

The screws SC2 and the mounting claw 68f are examples of a fixing section FP provided at a position accessible when the reading device 61 is in the open position. Note that the relay board cover 68 may be fixed to the reading device lower surface 61u by either the screws SC2 or the mounting claw 68f.

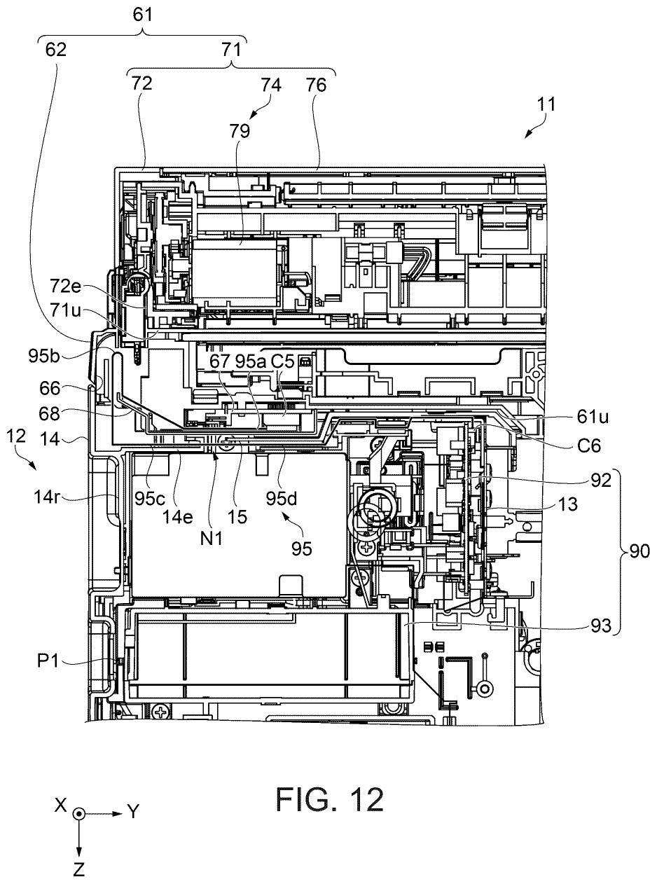

One end of the cable 95 is connected to the connector C5, and the other end of the cable 95 is connected to the connector C6 (see FIG. 8) of the control board 92, whereby the electrical component provided in the document transport section 74 and the control section 91 are electrically connected. As shown in FIGS. 8 and 12, the connector C6 is provided at a position at the −Z direction end of the +Y direction surface of the control board 92. The cable 95 is connected to and disconnected from the control board 92 by being connected to and disconnected from the connector C6 from the −Z direction along the Z-axis direction.

As shown in FIGS. 10 to 12, the cable 95 having one end connected to the connector C5 and the other end of connected to the connector C6, is formed with the advancing section 95a, a folding section 95b, an inversing section 95c, and an entry section 95d. When the reading device 61 is in the closed position, the advancing section 95a is a portion extending in the −Y direction toward the folding section 95b, from a position overlapping the relay board 67 at a position to the +Z direction side of the relay board 67. The +Z direction of the relay board 67 is the side of the relay board 67 that faces the device body 12.

As shown in FIG. 12, the folding section 95b continues from the advancing section 95a and is a curved portion where the extending direction of the cable 95 changes. At the folding section 95b, the cable 95 extends obliquely upward in the −Y direction and the −Z direction along the inner surface of the relay board cover 68 and enters the communication hole 66. At the folding section 95b, the cable 95 is curved in the communication hole 66, so that the extending direction thereof is changed to the +Z direction toward the extension section 14e of the exterior member 14, and advances from the opening of the communication hole 66 in the +Z direction.

The inversing section 95c continues after the folding section 95b and is the portion where the extending direction of the cable 95 changes to the +Y direction, which is the opposite direction of the advancing section 95a. In the inversing section 95c, the cable 95 extends in the +Y direction along a −Z direction surface, which is the upper surface of the extension section 14e of the exterior member 14.

In the routing of the cable 95, the position in the X-axis direction of the advancing section 95a, the folding section 95b, and the inversing section 95c is set to be the same. In the routing of the cable 95, the width direction of the cable 95 at the advancing section 95a, the folding section 95b, and the inversing section 95c is set in a direction along the axis A1.

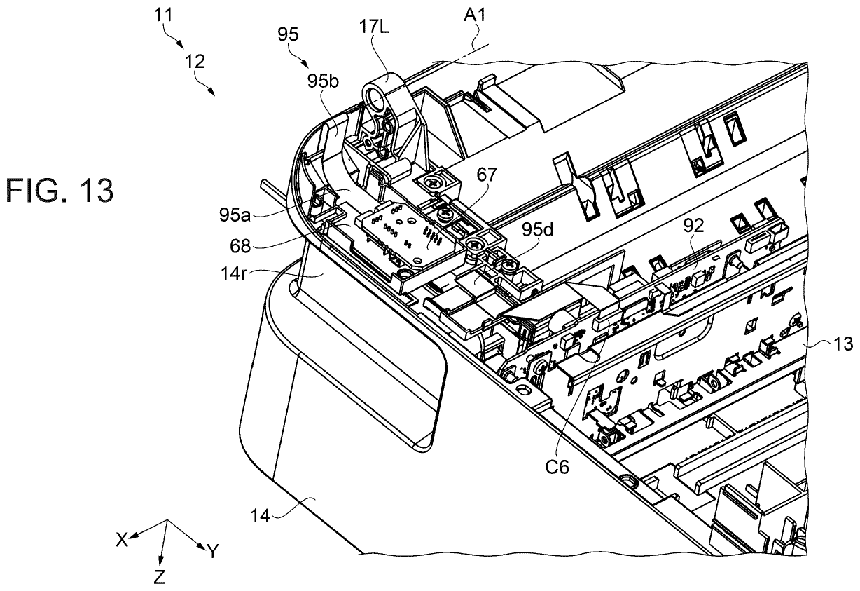

The entry section 95d is a section located in a region that is vertically below the electrical component cover 15 in the +Z direction. Continuing from the inversing section 95c, the cable 95 extending in the +Y direction enters a region vertically below the electrical component cover 15 via the gap N1. As shown in FIG. 13, the cable 95 changes its extending direction by being folded a plurality of times. The other end of the cable 95 is connected to a connector C6 on the control board 92.

For explanation, FIG. 13 illustrates the cable 95, the relay board 67 and the relay board cover 68 of the reading device 61 (to be described later). For explanation, FIG. 13, the electrical component cover 15 (to be described later) is removed.

In the embodiment, since the connection structure as described above is provided, the relay board cover 68 can be easily detached by moving the reading device 61 to the open position. In the embodiment, since the connection structure as described above is provided, the cable 95 can be easily connected to and disconnect from the connector C5 on the relay board 67. In this embodiment, since the connection structure as described above is provided, by removing the electrical component cover 15, the cable 95 can be easily connected to and disconnect from the connector C6 on the control board 92. Therefore, by setting the reading device 61 to the open position, the cable 95 can be easily connected to and disconnected from the reading device 61 and the device body 12.

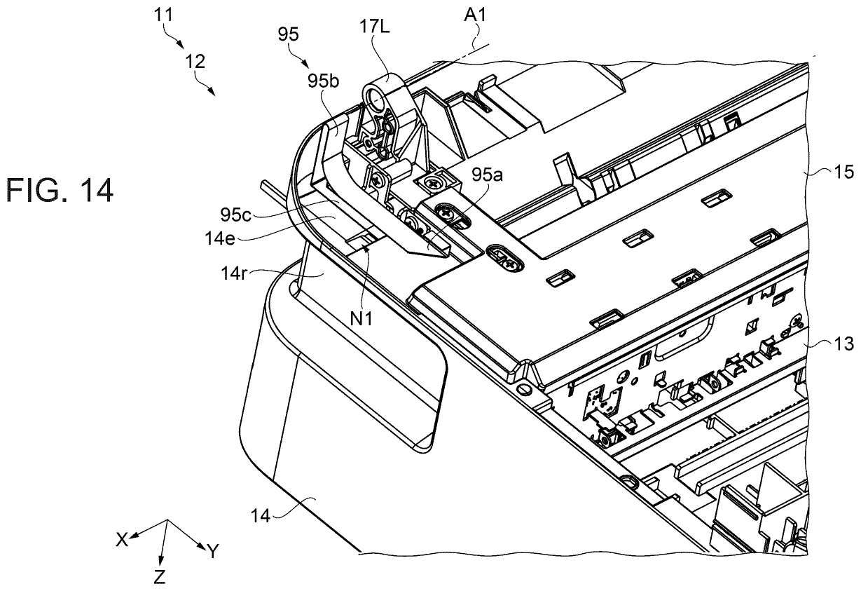

According to the present embodiment, as shown in FIG. 14, the advancing section 95a, the folding section 95b, and the inversing section 95c of the cable 95, of which the other end of which is connected to the connector C6, are positioned on the −Z direction side of the extension section 14e, which is above the device body 12. Therefore, the reading device 61 can be easily attached to and detached from the device body 12.

According to the embodiment, by placing the reading device 61 in the open position and removing the relay board cover 68, the wires W1, W2, W3, and W4 can be easily disconnected from the connectors C1, C2, C3, and C4 on the relay board 67. Thus, the document cover 71 can be easily removed from the reading device 61.

As described above, according to the image forming device 11 of the first embodiment, the following effects can be obtained.

The image forming device 11 includes a document transport section 74 that transports a document, and includes a reading device 61 that reads the document. The image forming device 11 includes a device body 12 having a recording section 50 that records on a medium M and a control section 91 that controls the document transport section 74. The device body 12 includes a control board 92 internally, on which the control section 91 is provided. The reading device 61 is provided so as to be openable and closable between an open position that exposes an upper portion of the device body 12 and a closed position that covers the upper portion by rotating about an axis A1 located on the rear side of the device body 12. The reading device 61 includes a relay board 67 on the reading device lower surface 61u that covers the upper portion of the device body 12. The document transport section 74 and the control section 91 are electrically connected by connecting the relay board 67 and the control board 92 with a cable 95. The relay board cover 68 that protects the relay board 67 and the cable 95 extending from the relay board 67 is provided on the reading device lower surface 61u. According to this, the cable 95 that connects the reading device 61 and the device body 12 can be easily removed. According to this, the assemblability and the disassemblability of the image forming device 11 are improved.

The document transport section 74 includes a document transport motor 79 that drives the document transport roller 83 that transports the document, and an encoder 80 that detects the rotation amount of the document transport motor 79. The document transport section 74 includes a document end detection sensor 81 that detects an end of the document and a document detection sensor 82 that detects the presence or absence of a document. The document transport section 74 and the relay board 67 are electrically connected to each other by four wires W1, W2, W3, and W4, which are connected to the document transport motor 79, the encoder 80, the document end detection sensor 81, and the document detection sensor 82, being connected to the relay board 67. The cable 95 is a flexible flat covered wire. According to this, it is possible to prevent damage to the electrical connection between the document transport section 74 of the reading device 61 and the control section 91 due to the opening and closing operation of the reading device 61 or the like.

When the reading device 61 is in the closed position, the relay board 67 is positioned vertically above a region of the device body 12, the region being outside a transport path TR through which the medium M is transported in X-axis direction and being closer to a rear side than a center of the device body 12. According to this, for example, when the reading device 61 is in the closed position, the length of the cable 95 can be shortened compared to the case where the relay board 67 is positioned vertically above the region that is further to the front side than the center of the device body 12. When the reading device 61 is in the closed position, it is easier to reduce the height dimension of the image forming device 11 compared to a case where the relay board 67 is positioned vertically above the transport path TR.

The cable 95 includes an advancing section 95a that extends along a Y-axis direction toward the control board 92 from a position on a side of the relay board 67 facing the device body 12 and overlapping the relay board 67 when the reading device 61 is in the closed position. According to this, it is possible to suppress an increase in the width dimension of the image forming device 11.

The relay board 67 is provided at a position closer to the axis A1 than the center of the reading device 61. According to this, it is easy to shorten the cable 95 compared to a case where the relay board 67 is provided at a position closer to the center of the reading device 61 than the axis A1.

The cable 95 is connected to and disconnected from the relay board 67 by being plugged and unplugged, along the reading device lower surface 61u, with respect to the connector C5 provided on the relay board 67. According to this, by moving the reading device 61 to the open position, it is possible to easily connect and disconnect the cable 95 with respect to the relay board 67.

The fixing section FP configured to detachably fix the relay board cover 68 to the reading device lower surface 61u is provided at a position on the reading device lower surface 61u that is accessible when the reading device 61 is in the open position. According to this, by placing the reading device 61 in the open position, it is possible to easily remove the relay board cover 68.

Although the image forming device 11 according to the above embodiment of the present disclosure is basically configured as described above, it is of course possible to change or omit the partial configuration within a range not departing from the scope of the present disclosure. The above described embodiment and other embodiments to be described below can be implemented in combination with each other within a technically consistent range. Hereinafter, other embodiments will be described.

In the above-described embodiment, the document transport section 74 may not include the document transport motor 79, the encoder 80, the document end detection sensor 81, and the document detection sensor 82. The document transport section 74 may include any one of a document transport motor 79, an encoder 80, a document end detection sensor 81, and a document detection sensor 82. For example, the document transport section 74 may not include the encoder 80, the document end detection sensor 81, and the document detection sensor 82. In this case, the document transport section 74 and the relay board 67 are electrically connected by one electrical wire W1 connected to the document transport motor 79 being connected to the relay board 67.

In the above-described embodiment, the cable 95 may not be a flexible flat covered wire. For example, the cable 95 may be a flexible covered wire having a circular cross section.

In the above-described embodiment, when the reading device 61 is located in the closed position, the relay board 67 may not be located vertically above the region of the rear side region of the device body 12 that is on the +X direction side of the transport path TR. For example, when the reading device 61 is in the closed position, the relay board 67 may be positioned vertically above a region of the rear side region of the device body 12 that is on the −X direction side of the transport path TR. For example, when the reading device 61 is in the closed position, the relay board 67 may be positioned vertically above the transport path TR in the rear side region of the device body 12.

In the above-described embodiment, when the reading device 61 is in the closed position, the advancing section 95a of the cable 95 may not extend along the Y-axis direction from a position that is on the side of the relay board 67 facing the device body 12 side and that overlaps the relay board 67. For example, the advancing section 95a may extend along the Y-axis direction from a position that does not overlap the relay board 67 when the reading device 61 is in the closed position.

In the above-described embodiment, the cable 95 may not enter the communication hole 66 at the folding section 95b. For example, the cable 95 in the folding section 95b may change the direction of extension by curving in the region between the communication hole 66 and the extension section 14e.

In the above-described embodiment, the relay board 67 may be provided at a position closer to the center of the reading device 61 than the axis A1 portion.

In the above-described embodiment, the connectors C1, C2, C3, C4, and C5 may not be provided on the +Z direction surface of the relay board 67. For example, the connectors C1, C2, C3, C4, and C5 may be provided on the −Z direction surface of the relay board 67. For example, the connectors C1, C2, C3, and C4 may be provided on the −Z direction surface of the relay board 67, and the connector C5 may be provided on the +Z direction surface of the relay board 67.

In the above-described embodiment, the wires W1, W2, W3, and W4 and the cable 95 may not need to be connected to and disconnected from the relay board 67 by being plugged and unplugged with respect to each of the connectors C1, C2, C3, C4, and C5 along the X-Y plane, that is, along the reading device lower surface 61u. For example, the electrical wire W1 may be connected to and disconnected from the relay board 67 by being plugged and unplugged along the Z axis direction with respect to the connector C1 provided on the −Z direction surface of the relay board 67. For example, the cable 95 may be connected and disconnected with respect to the relay board 67 by being plugged and unplugged along the Z-axis direction with respect to the connector C5 provided on the +Z direction surface of the relay board 67.

In the above-described embodiment, the fixing section FP configured to detachably fix the relay board cover 68 to the reading device lower surface 61u may not provided at a position on the reading device lower surface 61u that is accessible when the reading device 61 is in the open position. For example, the screws SC2 may be provided at positions accessible from the −Y direction of the reading device 61 when the reading device 61 is in the closed position.

What is claimed is:

1. An image forming device comprising:
a reading device that has a document transport section for transporting a document and that reads the document and
a device body including a recording section that records on a medium and a control section that controls the document transport section, wherein
the device body includes an internal control board on which the control section is provided, and
the reading device
is provided so as to be openable and closable between an open position that exposes an upper portion of the device body and a closed position that covers the upper portion, by rotating about an axis located on the rear side of the device body and
includes a relay board that is on a reading device lower surface and that covers the upper portion of the device body,
the document transport section and the control section are electrically connected by connecting the relay board and the control board with a cable, and
a relay board cover that protects the relay board and the cable extending from the relay board is provided on the reading device lower surface.

2. The image forming device according to claim 1, wherein
the document transport section includes
a document transport motor that drives a document transport roller that transports the document,
an encoder that detects rotation amount of the document transport motor,
a document end detection sensor that detects an end of the document, and
a document detection sensor that detects the presence or absence of the document,
the document transport section and the relay board are electrically connected to each other by four electric wires, which are connected to the document transport motor, the encoder, the document end detection sensor, and the document detection sensor, being connected to the relay board, and
the cable is a flexible flat covered wire.

3. The image forming device according to claim 1, wherein
when the reading device is in the closed position, the relay board is positioned vertically above a region of the device body, the region being outside a transport path through which the medium is transported with respect to a width direction of the medium to be transported and being closer to a rear side than a center of the device body.

4. The image forming device according to claim 1, wherein
the cable includes an advancing section that extends along a transport direction of the medium toward the control board from a position that is on a side of the relay board facing the device body and that overlaps the relay board when the reading device is in the closed position.

5. The image forming device according to claim 1, wherein
the relay board is provided at a position closer to the axis than the center of the reading device.

6. The image forming device according to claim 1, wherein
the cable is connected to and disconnected from the relay board by being plugged and unplugged along the reading device lower surface with respect to a connector provided on the relay board.

7. The image forming device according to claim 1, wherein
a fixed section configured to detachably fix the relay board cover to the reading device lower surface is provided on reading device lower surface at a position accessible when the reading device is at the open position.
